(19) United States
(12) Patent Application Publication
(10) Pub. No.: US 2010/0094654 A1
(43) Pub. Date: Apr. 15, 2010

(54) IMPLANTABLE STORAGE DEVICE FOR MAINTAINING MEDICAL RECORDS

(76) Inventor: Andrew Royal Stewart, Cape Girardeau, MO (US)

Correspondence Address: KANG INTELLECTUAL PROPERTY LAW, LLC, 214 ELM STREET, SUITE 106, WASHINGTON, MO, 63090, US

(21) Appl. No.: 12/477,735

(22) Filed: Jun. 3, 2009

Related U.S. Application Data
(60) Provisional application No. 61/058,404, filed on Jun. 3, 2008.

(51) Int. Cl. G06Q 50/00

(52) U.S. Cl. 705/3

(57) ABSTRACT

An implantable device to store electronic medical records (EMR) is described. The implantable medical records (IMR) device has read/write capabilities and incorporates a battery, integrated circuits, transceiving functionality and storage medium. The device is implanted subcutaneously through minimally invasive surgery in the desired location in the patient. The patient's medical records are then stored and updated on the device and are available to authorized health care professionals via the external components of the system. The external components of the system include a reader/programmer with transceiving functionality and required interface software so that authorized health care professionals may extract the medical records on the device as well as write to the device as necessary to keep the health records in the IMR device up-to-date.

### CROSS-REFERENCE TO RELATED APPLICATIONS

This application claims priority from U.S. Provisional Patent Application No. 61/058,404 filed Jun. 3, 2008, and which is incorporated by reference in its entirety.

### STATEMENT REGARDING FEDERALLY SPONSORED RESEARCH

Not Applicable.

### APPENDIX

Not Applicable.

### BACKGROUND OF THE INVENTION

1. Field of the Invention

The present invention is a device for maintaining medical records and, more specifically, is a device and system for an implantable storage device for maintaining medical records and a system for accessing the medical records from the implantable storage device.

2. Related Art

Various devices intended to reside in or on patients to store medical records have been described. Health record cards (U.S. Pat. No. 5,832,488) are a well-known technology wherein patients can carry a credit card sized device that stores their medical records for access and updating by authorized health care professionals. In implantable devices, the patents and applications describe devices with storage of reference codes to external health records stored on centralized databases. In some cases the devices themselves contain the health records of the patient. These descriptions have included passive transponder-based externally inductive implants in the armpit (U.S. Pat. No. 5,855,609) or other areas (US Published Patent Application No. 20070120683) as well as RFID (radio frequency identification) tags on implantable medical devices (hereinafter “IMD”) to identify the IMD itself (U.S. Pat. Nos. 7,218,232 and 7,333,013). In addition, implants in the eye (US Published Patent Application No. 20080091178) and adhesions to teeth (US Published Patent Application No. 20060244569) have been described that store medical information using indica or small read/write RF (radio frequency) chips. In animal and livestock applications, transponder-based devices that are administered orally to the animal and stored in the stomach have been described (U.S. Pat. No. 6,012,415).

There are many scenarios wherein a physician or health care professional (HCP) needs a patients' medical records or history in order to deliver the most effective treatment quickly so as to maximize the benefit of that healthcare for the patient. Such scenarios include, but are not limited to:

Emergency room (hereinafter “ER”) visits wherein a patient presents with chest pain and the ER physician needs to see a previous electrocardiogram, any and all previous heart catheterization or cardiac surgery reports and needs to know the type and manufacturer of pacemaker or ICD, if any, the patient has implanted.

Similar to above wherein a patient presents to the ER with syncope, the ER physician needs to know whether or not the patient is a diabetic, if the patient has any known heart disease and/or if the patient has any previously diagnosed aneurysms.

Similar to above wherein a patient presents to the ER with shortness of breath and symptoms of heart failure, the ER physician needs to know if the patient has a prior history of heart failure and what heart medicines the patient is on. The physician also needs to know if the patient has previously been diagnosed with chronic obstructive pulmonary disease (COPD) or if the patient has previously had an echocardiogram and what the function of the patient's heart was at that time.

Similar to above wherein a patient presents with headaches, the ER physician needs to know if the patient has had any prior CAT scans and what, if anything, they revealed.

Similar to above wherein a patient presents with trauma, the ER physician needs to know if the patient is on any anti-coagulation therapy, what the patient's tetanus status is and also if the patient has had any prior surgeries.

Similar to above wherein the patient is pediatric and the ER physician needs to know whether or not the patient's immunizations are up-to-date.

Doctor's office visits wherein a patient establishes with a new physician and the physician needs to know what previous diagnoses, surgeries or tests the patient has had as well as their outcomes and current status. The physician will also need a current and accurate medication list.

When a patient is sent to a cardiologist, the cardiologist needs to see any prior stress test results, echo results, electrocardiograms, holter monitor results or prior surgical reports.

When a heart patient with congenital heart disease and multiple prior surgeries establishes with a cardiologist, the cardiologist needs all prior cardiac surgical reports.

When a patient is referred to an out-of-town or out-of-state specialist for treatment, the receiving physician will need the medical records of the patient to treat them appropriately and the referring physician will need the medical records that resulted from the referral to treat the patient appropriately upon their return.

When a patient spends half the year in one location and the other half in another location, their physicians in both places will need current and accurate medication lists to treat the patient effectively.

In the scenarios listed, as well as most others, physicians also need a current and accurate medication list as well as a list of any allergies the patient has in order to correctly diagnose and treat the patient.

In addition to addressing these and other healthcare scenarios, immediate access to a patient's complete and accurate healthcare and pharmacologic history will also significantly reduce healthcare costs by minimizing unnecessary medical testing, incorrect diagnoses, inappropriate and ineffective therapy and/or incorrect and inappropriate pharmacologic changes.

What is needed is an implantable read/write storage device intended to store the patient's updated medical records and history as a quick and accurate resource for any authorized healthcare professional. The device and system described herein addresses the above mentioned needs and serves the purposes of maximizing the speed and effectiveness of healthcare delivery to the patient while controlling the cost of healthcare by minimizing healthcare mysteries and their subsequent redundancies and errors.

### SUMMARY OF THE INVENTION

The present invention describes a subcutaneous implant device that stores all of a patient's electronic medical records for patient safety, reliability and convenience. It includes a transceiving communication component and storage capacity in addition to a battery and computing component ensuring an acceptable longevity for the device. The system also includes the external components of a reader/programmer with software that may include the use of the health care provider's computer system and access to his/her EMR.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

In the accompanying drawings which form part of the specification:

FIG. 1 is a schematic of an implantable storage device in accordance with and embodying the present invention; and

FIG. 2 is a schematic of the system including the device, communication module (wand), and a Health Care Professional (HCP) computer installed with IMR software. FIG. 2 also illustrates an external reader/programmer in accordance with and embodying the present invention; and

FIG. 3 is a schematic of the system including the device, communication module (wand), and HCP system with EMR records which illustrates the link, directly and via the internet using a home transmitter, between the EMR records and the IMR in accordance with and embodying the present invention; and

FIG. 4 is an illustration a patient implanted with an IMR being evaluated in the doctor's office using the HCP system and communication module (wand) in accordance with and embodying the present invention; and

FIG. 5 is a schematic illustrating the software interface installed and viewable on the HCP system and/or on the external reader/programmer that the HCP uses to view, add and manipulate records stored on the IMR in accordance with and embodying the present invention; and

FIG. 6 is a software flowchart illustrating the various functions and components of the software and their interactions with each other and the user. Through this software interface, the HCP can view, add and manipulate the medical and pharmacologic records in the IMR.

Corresponding reference numerals indicate corresponding parts throughout the several figures of the drawings.

### DETAILED DESCRIPTION OF THE PREFERRED EMBODIMENTS

The following description of the preferred embodiment(s) is merely exemplary in nature and is in no way intended to limit the invention, its application, or uses.

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

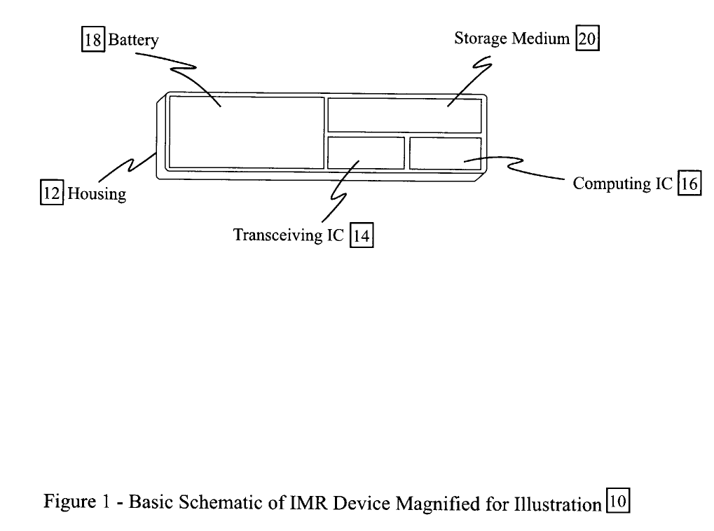

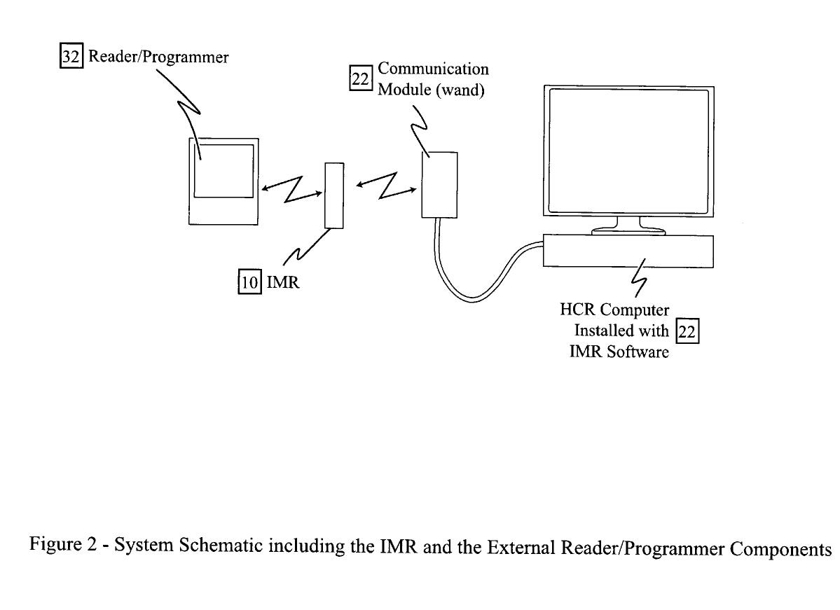

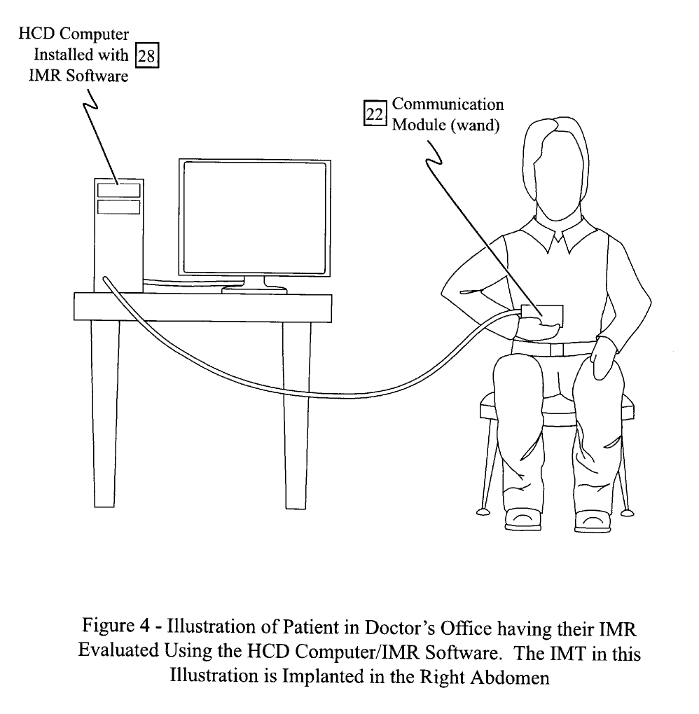

As shown in FIG. 1, an embodiment of the present invention, is generally referred to as an implantable storage device 10 for maintaining electronic medical records (EMR), includes a housing 12 with a transceiving I/C 14, a computing I/C 16, a power source (battery) 18, and a solid state memory storage medium 20. As shown in FIGS. 2-6, an embodiment of the external, non-implantable portion of the system includes a communication module (wand) 22, interface software 24, and a home transceiver 26. The system uses the Health Care Provider's (HCP) computer 28 and EMR records 30, otherwise alternatively referred to as electronic medical data, as a conduit and resource for interface and manipulation of the IMR. The system can also use an external reader/programmer 32 in conjunction with or independent of the communication module (wand) 22 as a conduit for interface and manipulation of the records stored in the IMR.

The housing 12 of the device is a strong, hard, biocompatible material such as titanium, or titanium alloy, that contains all of the components of the device and maintains the integrity of the device during and after implantation. In size, the housing is small enough to be implanted with minimally invasive surgery but still contain all the required components referenced above and below. The transceiving I/C 14 in the device will be necessary for telemetry to and from an external HCP computer 28 or the reader/programmer 32. The HCP computer 28 will also have a communication module (wand) 22 which will incorporate a transceiving I/C to communicate with the transceiving I/C in the device. The external reader/programmer 32 can incorporate a transceiving I/C directly or it can utilize a communication module (wand) 22 for communication with the IMR. The computing I/C 16 in the device will perform the administrative and software tasks in the device to ensure the security of the device software and information. It will also run the read/write processes of the device when updating occurs through external HCP computers 28 or reader/programmers 32 and will maintain the integrity of the EMR in the device between HCP visits via a low energy “housekeeping” current from the battery 18. The battery 18 will be a small power source that will spend most of its time in the “housekeeping” mode whereby it will maintain the integrity of the EMR and software within the device. It will have enough power to drive the transceiving I/C 14 and the computing I/C 16 when the device is read or written to by an authorized HCP and it will supply the device with enough power to accomplish these tasks enough times so as to provide the device with a reasonably long operating life-span.

The memory storage medium 20 is, preferably, a solid state non-volatile random access memory, such as flash memory, but other types of storage mediums can also be used. The device will have enough memory storage capacity to store comprehensive, historical EMR, including medications, from all of the patient's HCPs into the future. The memory storage medium 20 stores EMR for reading, display, assessment and manipulation by authorized persons, such as the patient's doctors or healthcare professionals. The EMR on the memory storage medium 20 acts as the master record and, therefore, would always be the most up-to-date data of the patient's medical history and current status including, but not limited to, current and past medications and ailments.

The interface is wireless, local, encrypted secure telemetry to a communication module (wand) 22 that is connected via USB or other communications port to an authorized readout device such as a computer terminal 28 or reader/programmer 32, allowing the device to communicate EMR. The reader/programmer interface can, in an alternate embodiment, incorporate the transceiving I/C in its casing and therefore not require the communication module (wand) 22. In this way, authorized persons can access and manage the data stored on the storage medium 20 using software 24 that is installed on the HCP computer 28 or reader/programmer 32. The software 24 will allow authorized persons to input, manage and manipulate the medical records stored in the device 10. The software 24 will also display and convey the patient's health and medical status including their medications, allergies and current following doctors. Further medical record detail will be available from the device 10 through the software 24 by interacting and manipulating the software's tabs and input/output functions.

Due to privacy concerns regarding personal medical information, the device includes security features. The device will have a password protection feature available if the patient wants to incorporate password security. The patient simply inputs or enters a previously designated password to access the IMR within the IMR. For further protection, the password can only be entered while the device is within a predetermined distance from an authorized computer or reader/programmer with IMR software installed such as would be found at the doctor's office, hospital, clinic or ambulance. This restricts access to EMR by non-authorized persons. The downside of password protection is the unavailability of the IMR information in the IMR should the patient ever need medical attention in an unconscious state. For patients with this or other concerns, password protection can be disabled if they choose. The system would still require an authorized IMR software installed computer or reader/programmer to interact with a patient's IMR device as would only be used by an HCP. In addition, the HCP computer or reader/programmer would also require that its transceiving I/C be close enough to the patient's IMR such that the transmission signal to noise ratio maintains a predetermined minimum value which allows for acceptable telemetry signal strength and security but does not exceed twelve inches. For the HCP computer embodiment 28, this would require that the communication module (wand) 22, be within a certain distance of the patient's IMR. For the reader/programmer embodiment 32, this would require that the reader programmer or, if utilized, its associated communication module (wand) 22 be within a certain distance of the patient's IMR. In this way, only HCPs will have access to the patient's EMR on the implantable device and only if the patient allows that access.

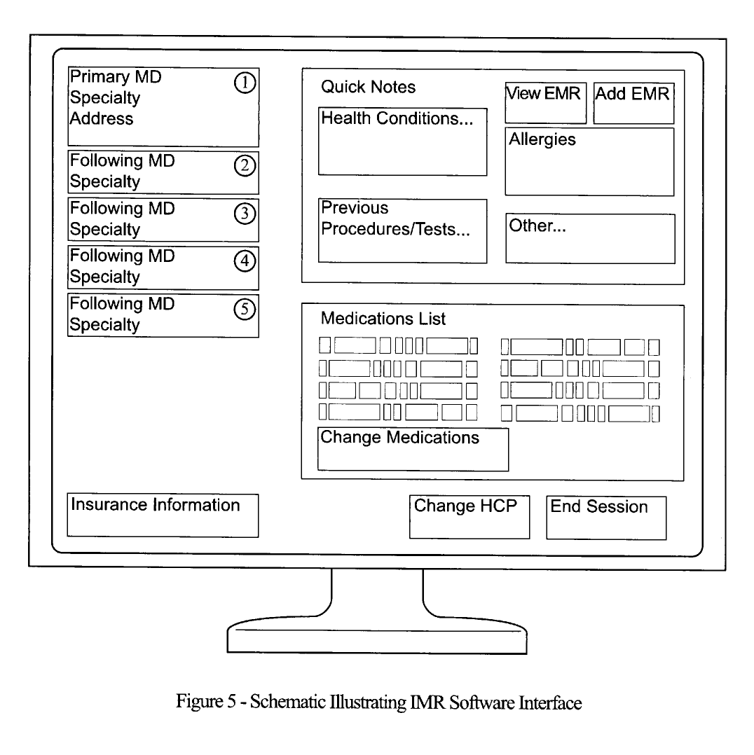

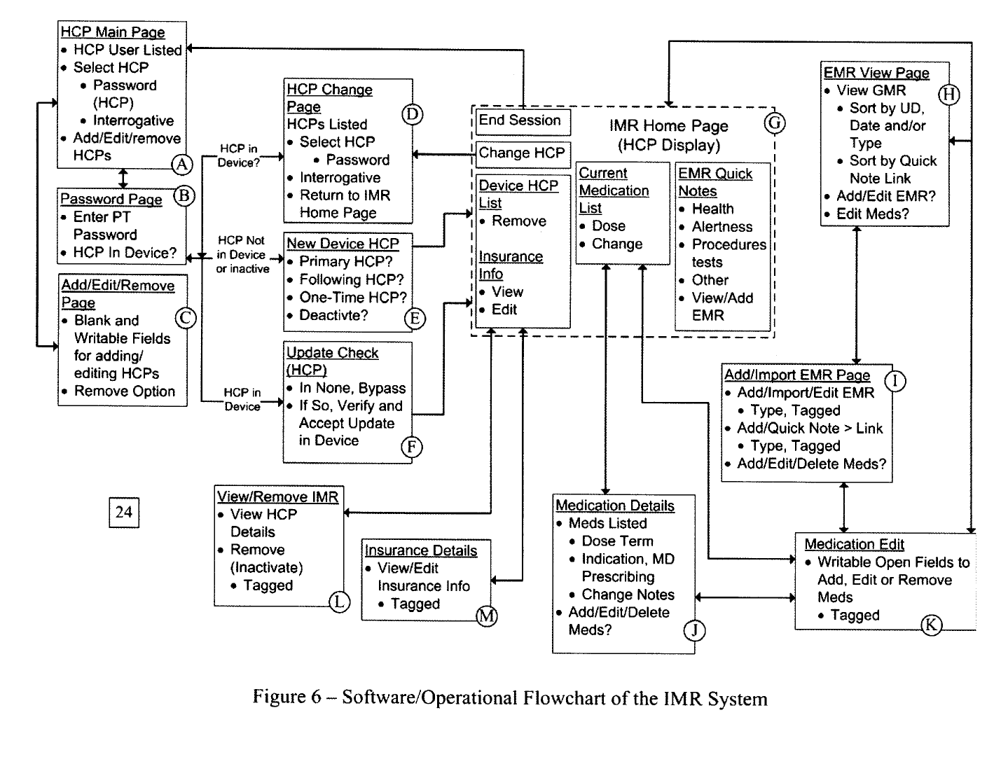

In the external HCP computer embodiment 28, software 24 via a CD-ROM is provided, with a communication module (telemetry wand) 22 that incorporates a USB connector or other comport, to any and all authorized HCPs that request it. The same software 24 will be installed and utilized on the external reader/programmer 32 to communicate and manipulate the records on patient's IMRs. As shown in FIGS. 5 and 6, the software, available on the reader/programmer 32 and/or installed on the HCP's computer 28, will provide an interface that will allow authorized HCPs to view, add and manage the EMR within the device. The software's “main page” will display important, basic information regarding the patient's health history including the patient's medical conditions, history and any major surgeries. It will also display the patient's current medications, physicians and insurance status. “Tabs” and user input functions on the main page and throughout the software will allow HCPs to update and manage the patient's EMR and medication records on the device.

FIG. 6 illustrates a software and operational flowchart to describe the function of the system and its interaction with an HCP user. Boxes A-F illustrate the software, with input and downloading of information to and from the IMR, as it exists primarily in the HCP's computer or the reader/programmer. Box A represents the HCP computer or external reader/programmer “Main Page”. This page will list the HCPs that are programmed and saved as users in the software and will also contain HCP password protection. By selecting the HCP and then entering the HCP's password (if HCP password protection is required), the HCP can begin to read/interrogate the patient's IMR. A link on this page will also allow users the option of adding/editing or removing HCPs as users of the software in the Add/Edit/Remove HCP page represented by Box C.

Once the HCP initiates an IMR reading, the software checks if the patient password protection is enabled and requires that the HCP enter the correct password for full interrogation of the device as represented in Box B. Also, at this point, the software establishes whether or not the user HCP is a preexisting HCP saved in the device. If the HCP is already programmed in the device and the user HCP's practice and status matches the “stored HCP”, the software displays the “IMR Homepage” represented by Box G. This process of checking that the HCP is programmed in the device and verifying necessary HCP updates is represented by Box F.

If the software establishes that the user HCP is not already programmed into the IMR and is “new” to the device, it opens up the “New Device HCP Page” as illustrated by Box E. In this page the software provides the option of listing the user HCP as one of the patient's HCPs on the “IMR Homepage”. This includes the option of listing the user HCP as the patient's Primary HCP if it's not already established or listing the user HCP as a following HCP in the device. This process of inputting the user HCP's information into the IMR allows the device to “tag” all changes or additions the user HCP makes to the data in the IMR with the user HCP's information. Another option the software allows the HCP is that of entering as a one-time HCP whereby their name will not appear on the “IMR Homepage” at future “readings” but the device will still “tag” any EMR additions or pharmacologic changes the HCP makes with the HCP's information. Also on this page is the option of reactivating the user HCP if that HCP had previously been inactivated in the device.

Box G is the “IMR Homepage” that represents the information in the IMR and acts as a conduit to add to and edit that information. The three main areas of the “IMR Homepage” are the “Device HCP List”, the “Current Medication List” and the “EMR/Quick Notes”. In addition, the current HCP user is displayed on this, as well as all other, IMR View/Edit pages to illustrate that their “tag” is being attached to all EMR changes in the current “reading/interrogation” session. Also on this page are the options of ending the “reading/interrogation” session whereby communication and updates with the IMR are terminated, and changing the HCP user whereby the system directs the user to the “HCP Change Page” represented by Box D. The “End Session” option returns the user to the “HCP Main Page” and the “HCP Change Page” allows the current HCP user to be changed to another of the HCPs saved in the HCP software. This option prevents a new HCP user from having to end the session to enter new EMR/pharmacologic data into the patient's IMR. It also repeats the steps of requiring HCP password input for the new HCP user as well as identifying whether or not the new HCP is already in the device and giving the new HCP the same IMR status options as the initial HCP user upon interrogation as illustrated by Boxes E & F.

The “Device HCP List” on the “IMR Homepage” lists the HCPs that have “read” the device and listed themselves as one of the patient's following HCPs. The first HCP listed will be the patient's primary HCP. In addition, the Homepage will display basic information about each HCP including their name and specialty. By clicking any one of the HCPs listed, the software will display the “View/Remove IMR HCP” page, as represented by Box L. This page displays details about the. HCP, including their address and last “reading”, and will give the user the option of inactivating IMR HCPs. Inactivation of an HCP will remove that HCP from the “IMR Homepage” but will not delete that HCP from the IMR memory nor will it delete any of the inactivated HCP's EMR/pharmacologic changes or their “tags” to that HCP. In addition, the inactivation itself will be “tagged” by the inactivating HCP.

The “Device HCP List” also includes basic Insurance information for the patient. By clicking on the insurance tab, the software will open up the “Insurance Details Page”, as represented by Box M, wherein the HCP user can view details of the patient's insurance information and edit it if necessary. As with all changes/additions to the IMR device, editing the insurance information will be tagged with the user HCP's information.

The “Current Medication List” on the “IMR Homepage” will simply list all of the patient's current medications and doses. By clicking on the medications, the software will display the “Medication Details” page, represented by Box J, wherein each medication is listed along with its dose, term, original indication for use, original prescribing HCP, original prescribing date, changes, dates and the accompanying tagged HCPs and any relevant notes regarding the medication. In addition, on both the “Current Medication List” and the “Medication Details” page will be direct links to the “Medication Edit” page, represented by Box K, wherein the HCP will have the option of adding, deleting or editing the patient's current medication list. As with all additions, deletions or edits to the IMR device, the system will “tag” the medication changes with the user HCP's information.

The “EMR/Quick Notes” on the “IMR Homepage” will display the patient's Quick Notes which are further divided into four categories: “Health Conditions”. “Previous Procedures/Tests”, “Allergies” and “Other”. The Quick Notes are brief diagnoses or health status notes that the patient's HCPs have prioritized as being the most important of the patient's medical records and categorized into one of the four Quick Notes sections. When the HCP originates the Quick Note he/she will have the option of linking it to an EMR entry in the IMR. This will allow the HCP to include more detail about the Quick Note in the device including attaching a full diagnosis report, a history and physical evaluation report and/or a procedure or test report. By clicking on any of the linked Quick Notes the user HCP is directed to the “View EMR” page, as represented by Box H, wherein the medical record that is linked to that Quick Note is displayed.

In addition to the Quick Notes, the “EMR/Quick Notes” has direct links to the “Add/Import EMR” page, represented by Box I, and the “View EMR” page, represented by Box H. In the “Add/Import EMR” page the user HCP will have the option of manually entering EMR or Quick Notes into the device or importing EMR from their EMR system or other secure EMR source. In addition, the user HCP will have the option of assigning a “Type” to the EMR or Quick Note entry. The “Types” include: “Clinic Note”, “Hospital Note”, “Procedure Note”, “Test Note” or “Other Note”. This is also the point at which the HCP will have the option of linking Quick Notes to EMR entries in the device or of removing a Quick Note from the “IMR Homepage”. As with all added and edited records in the IMR, the Quick Notes and added EMR will be “tagged” with the inputting HCPs information. The added/imported EMR will be editable until the user HCP ends the session. Once the session has ended, the EMR is locked into the device and can not be edited. The “Add/Import EMR” page will also have links to the “Medication Edit” page, as described above and represented by Box K, and the “View EMR” page, represented by Box H.

In the “View EMR” page, represented by Box H, the user HCP can view any EMR that has been input to the device. The user HCP will be able to sort and view EMR by linked Quick Note, tagged HCP, date and/or type. The “View EMR” page will also have links to the “Add/Import EMR” page, represented by Box I, and the “Medication Edit” page, represented by Box K.

In a further embodiment of the system, a synchronization function will be in the software which will allow authorized persons to quickly synchronize the doctor's EMR 30 with those in the IMR 10. This will simplify the input of EMR data into the device 10 at initial and recurrent HCP visits and will allow other HCPs to “load” the EMR from the IMR to their EMR systems regardless of what EMR system they use. It will also allow the HCP to select the degree of completeness he/she wishes to load of their EMR on the IMR in addition to allowing the HCP to select, directly or indirectly, the importance of the records and thus how they are displayed in the IMR interface software. In this way, the system seamlessly traverses boundaries worldwide and the patient can travel with his/her EMR and not have to worry about language or EMR format issues should he/she need medical attention wherever they are. It could also be updated by any medical professional in the world with EMR capabilities.

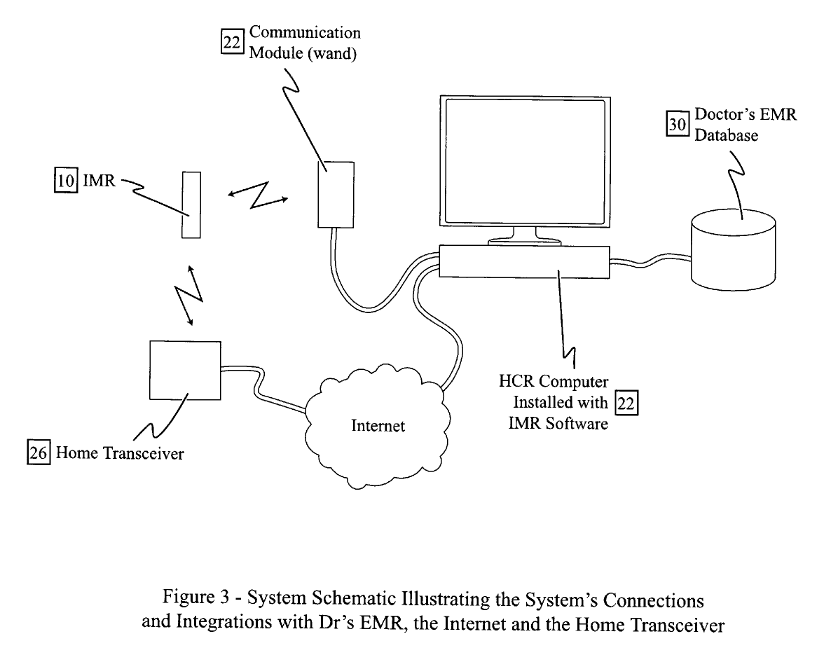

As shown in FIG. 3, a further embodiment would include a home transceiver 26 that would automatically update and synchronize the patient's IMR device with the HCP's office EMR to ensure that both systems are always up to date. This would be useful when patients get out of office tests performed and results obtained and when medications are changed to ensure that both the HCP's EMR and the patient's IMR are synchronized. The home transceiver 26 would be connected to the internet either through a phone line or a computer and would sit in close proximity to the patient when he/she is at home (such as next to their bed). Each home transceiver would be specific to one patient's IMR and would securely receive and transmit updates to and from the patient's HCP. In one embodiment of this system, the home transceiver 26 would contain a home communication module (wand) such as that at the HCP office so that patient interaction is required to perform updates. In another embodiment of this system the home transceiver 26 and the IMR device 10 would both contain longer range RF transceivers that would allow for frequent automatic updates so that no patient interaction is required (such as when the patient is sleeping). In both systems, device specificity, security and data encryption would be required to ensure the protection of every patient's EMR.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A storage system for storing data, wherein said data can be manipulated, added to and subtracted from, with the primary intended purposes, comprising:
an implantable device, comprising
a housing for implantation within a human being;
a memory storage medium disposed within said housing for storing electronic medical data;
an integrated circuit for transceiving and computing;
an interface for communicating electronic medical data from said storage medium device;
a power source located within the housing and operatively connected to said storage medium, said integrated circuits, and said interface; and
an external reader in communication with said interface of said implantable device, and adapted to extract electronic medical data from said memory storage medium via said interface of said implantable device, and further adapted to communicate new electronic medical data to said implantable device for storage in said memory storage medium via said interface of said implantable device.

2. The storage system of claim 1, wherein said memory storage medium of said implantable device stores comprehensive and historic patient health and medical information.

3. The storage system of claim 1, wherein said external reader further comprises:
communications hardware;
a transceiver for communicating between said communications hardware to said interface of said implantable device;
a computer for storing and updating electronic medical data;
communications software disposed in said computer for operating said computer, said communications hardware, for conducting telemetry between said external reader and said implantable device, and for effecting change in the electronic medical data stored in said memory storage medium of said implantable storage device.

4. The storage system of claim 3, wherein said communications hardware comprises a wand.

5. The storage system of claim 3, wherein said communications software comprises an interface between said external reader and said interface of said implantable device, and allows one operation to be completed selected from the following group:
check whether password protection has been enabled in said implantable device; determine whether a user health care provider has electronic medical data stored in said memory storage medium of said implantable device; display an image medical record stored in said memory storage medium of said implantable device; write an image medical record to said memory storage medium of said implantable device; display basic insurance information stored in said memory storage medium of said implantable medical device; write basic insurance information to said memory storage medium of said implantable device; display a medication list stored in said memory storage medium of said implantable device; write a medication list to said memory storage medium of said implantable device; display health conditions stored in said Memory storage medium of said implantable device; write health conditions to said memory storage medium of said implantable device; display previous procedures stored in said memory storage medium of said implantable device; write previous procedures to said memory storage medium of said implantable device; display previous tests stored in said memory storage medium of said implantable device; write previous tests to said memory storage medium of said implantable device; display allergies stored in said memory storage medium of said implantable device; write allergies to said memory storage medium of said implantable device; display notes stored in said memory storage medium of said implantable device; write notes to said memory storage medium of said implantable device

6. The storage system of claim further comprising:
a home transceiver, adapted to automatically update and synchronize electronic medical data in said memory storage medium of said implantable device, connected to a computer network, in communication with said external reader.
